(19) United States
(12) Patent Application Publication
(10) Pub. No.: US 2025/0081257 A1
(43) Pub. Date: Mar. 6, 2025

(54) Device-to-Network Relaying for an Emergency Service

(71) Applicant: Telefonaktiebolaget LM Ericsson (publ), Stockholm (SE)

(72) Inventors: Cheng Wang, Shanghai (CN); Monica Wifvesson, Lund (SE); Zhang Fu, Stockholm (SE); Juying Gan, Shanghai (CN)

(21) Appl. No.: 18/574,944

(22) PCT Filed: Sep. 29, 2023
(86) PCT No.: PCT/EP2023/077113

§ 371 Date: Dec. 28, 2023

(30) Foreign Application Priority Data
Sep. 30, 2022 (WO) PCT/CN2022/123440

(51) Int. Cl. H04W 76/11; H04W 48/16; H04W 88/04

(52) U.S. Cl. CPC H04W 76/11; H04W 48/16; H04W 88/04

(57) ABSTRACT

A relay communication device (12) is configured to relay traffic (18) for a remote communication device (14). The relay communication device (12) receives, from the remote communication device (14), an equipment identifier (20) associated with the remote communication device (14). Alternatively or additionally, the relay communication device (12) transmits, to a network node (22) in a communication network (10), a report (24) that reports an equipment identifier (20) associated with the remote communication device (14) as identifying the remote communication device (14) for which the relay communication device (12) is to relay traffic (18).

### TECHNICAL FIELD

The present application relates generally to device-to-network relaying and relates more particularly to relaying for an emergency service.

### BACKGROUND

Proximity services (ProSe) in a communication network enable communication devices that are in proximity of one another to communicate directly, via a path not traversing any network node. Proximity services relaying exploits ProSe so that one communication device can relay traffic for another communication device in proximity. For example, a so-called ProSe device-to-network relay is a communication device that relays unicast traffic between a remote communication device and the communication network. Via a Pro-Se device-to-network relay, then, the remote communication device can communicate with the network even if the remote communication device is outside of the network's coverage.

To support traffic relaying, the relay communication device reports an identifier for the remote communication device to the communication network, e.g., so that the communication network can track which sessions are for relaying traffic for the remote communication device. The reported identifier can be a subscription identifier stored on an integrated circuit card of the communication device, e.g., a subscription concealed identifier (SUCI) stored on a Universal Subscriber Identity Module (USIM). Or, the reported identifier can be a proximity services relay user key (PRUK) identity bound to a proximity services relay user key that is generated during authentication of the remote communication device, for protecting an interface between the relay and remote communication devices.

Challenges exist, though, in enabling support for relaying traffic for an emergency service, e.g., 112 or 911 calls. Indeed, given the emergency nature of an emergency service, the traffic should be relayed even if the remote communication device lacks an integrated circuit card (e.g., USIM) and/or even if authentication of the remote communication device fails. Yet if the remote communication device lacks an integrated circuit card and authentication can't be completed, then the relay communication device heretofore has no identifier to report to the communication network for use by the communication network in identifying the remote communication device. Existing approaches therefore fail to adequately support emergency service relaying under some circumstances.

### SUMMARY

Some embodiments herein exploit an equipment identifier associated with a remote communication device for identifying the remote communication device in a context where a relay communication device relays traffic for the remote communication device. The equipment identifier may for instance be an International Mobile Equipment Identity (IMEI). By exploiting such an equipment identifier, some embodiments advantageously provide more robust support for emergency service traffic relaying. Indeed, because the equipment identifier is available even if the remote communication device lacks an integrated circuit card and even if the remote communication device cannot be authenticated, some embodiments support emergency service traffic relaying even in this case.

More particularly, embodiments herein include a method performed by a relay communication device configured to relay traffic for a remote communication device. The method comprises receiving, from the remote communication device, an equipment identifier associated with the remote communication device. In this case, the method alternatively or additionally comprises transmitting, to a network node in a communication network, a report that reports an equipment identifier associated with the remote communication device as identifying the remote communication device for which the relay communication device is to relay traffic.

In some embodiments, the method also comprises relaying traffic between the remote communication device and the communication network.

In some embodiments, the method comprises receiving the equipment identifier. In some embodiments, the equipment identifier is received in a request for the relay communication device to relay traffic for the remote communication device. In some embodiments, the request is a Direct Communication Request, DCR. In some embodiments, the request requests the relay communication device to relay traffic for the remote communication device for an emergency service. In some embodiments, the request includes an emergency relay service code. In some embodiments, the method further comprises receiving, from the remote communication device, a request for the relay communication device to relay traffic for the remote communication device. In this case, the method further comprises making a decision to transmit the identity request to the remote communication device, based on the received request lacking the equipment identifier. In some embodiments, the identity request is transmitted according to the decision. In some embodiments, the identity request is a Remote Identity Request or is included in a Direct Security Mode Command message.

In some embodiments, the method comprises transmitting the report. In some embodiments, the report is a Remote User Equipment Report. In some embodiments, the network node implements a Session Management Function, SMF.

In some embodiments, the equipment identifier is a Permanent Equipment Identifier, PEI.

In some embodiments, the equipment identifier is an International Mobile Equipment Identity, IMEI, or an IMEI Software Version, IMEISV.

In some embodiments, the relay communication device is to relay traffic for the remote communication device for an emergency service.

In some embodiments, the method further comprises receiving the equipment identifier and/or transmitting the report reporting the equipment identifier, based on the traffic being for an emergency service and/or based on receiving an emergency service relay code.

In some embodiments, the remote communication device lacks a universal integrated circuit card, or subscriber identity module, for storing a subscription identity associated with the communication device.

In some embodiments, the method further comprises making a decision to skip a security procedure with the remote communication device, based on the relay communication device receiving the equipment identifier and/or an emergency relay service code. In this case, the method further comprises, in accordance with the decision, skipping the security procedure with the remote communication device.

In some embodiments, the method further comprises, based on failure of or skipping of a security procedure with the remote communication device, performing a direct security mode command procedure with null ciphering and integrity protection. In some embodiments, performing the direct security mode command procedure includes transmitting a message of the direct security mode command procedure with a flag indicating an algorithm chosen for the null ciphering and integrity protection. In some embodiments, performing the direct security mode command procedure includes setting a root key to a value specific for null ciphering and integrity protection and/or setting each of one or more session keys to a value specific for null ciphering and integrity protection.

In some embodiments, the relay communication device is a Layer-3 UE-to-Network Relay or a 5G Proximity Services, ProSe, UE-to-Network Relay.

In some embodiments, the remote communication device is a 5G ProSe Remote User Equipment.

Other embodiments herein include a method performed by a remote communication device. The method comprises transmitting, to a relay communication device configured to relay traffic for the remote communication device, an equipment identifier associated with the remote communication device.

In some embodiments, the method further comprises transmitting traffic to a communication network via the relay communication device, with the equipment identifier identifying the remote communication device to the communication network.

In some embodiments, the equipment identifier is transmitted in a request for the relay communication device to relay traffic for the remote communication device. In some embodiments, the request is a Direct Communication Request, DCR. In some embodiments, the request requests the relay communication device to relay traffic for the remote communication device for an emergency service. In some embodiments, the request includes an emergency relay service code.

In some embodiments, the method further comprises receiving, from the relay communication device, an identity request requesting information identifying the remote communication device. In some embodiments, the equipment identifier is transmitted in response to the identity request. In some embodiments, the method further comprises transmitting, to the relay communication device, a request for the relay communication device to relay traffic for the remote communication device, wherein the request lacks the equipment identifier. In some embodiments, the identity request is received after transmitting the request. In some embodiments, the identity request is a Remote Identity Request or is included in a Direct Security Mode Command message.

In some embodiments, the equipment identifier is a Permanent Equipment Identifier, PEI.

In some embodiments, the equipment identifier is an International Mobile Equipment Identity, IMEI, or an IMEI Software Version, IMEISV.

In some embodiments, the relay communication device is to relay traffic for the remote communication device for an emergency service.

In some embodiments, the method further comprises transmitting the equipment identifier, based on the traffic being for an emergency service and/or based on transmitting an emergency service relay code.

In some embodiments, the remote communication device lacks a universal integrated circuit card, or subscriber identity module, for storing a subscription identity associated with the communication device.

In some embodiments, the method further comprises, based on failure of or skipping of a security procedure with the relay communication device, performing a direct security mode command procedure with null ciphering and integrity protection. In some embodiments, performing the direct security mode command procedure includes receiving a message of the direct security mode command procedure with a flag indicating an algorithm chosen for the null ciphering and integrity protection. In some embodiments, performing the direct security mode command procedure includes setting a root key to a value specific for null ciphering and integrity protection and/or setting each of one or more session keys to a value specific for null ciphering and integrity protection.

In some embodiments, the relay communication device is a Layer-3 UE-to-Network Relay or a 5G Proximity Services, ProSe, UE-to-Network Relay.

In some embodiments, the remote communication device is a 5G ProSe Remote User Equipment.

Other embodiments herein include a method performed by a network node in a communication network. The method comprises receiving, from a relay communication device configured to relay traffic for the remote communication device, a report that reports an equipment identifier associated with the remote communication device as identifying the remote communication device for which the relay communication device is to relay traffic.

In some embodiments, the method further comprises using the equipment identifier to identify the remote communication device and/or to determine that the remote communication device has an ongoing session.

In some embodiments, the report is a Remote User Equipment Report.

In some embodiments, the network node implements a Session Management Function, SMF.

In some embodiments, the equipment identifier is a Permanent Equipment Identifier, PEI.

In some embodiments, the equipment identifier is an International Mobile Equipment Identity, IMEI, or an IMEI Software Version, IMEISV.

In some embodiments, the relay communication device is to relay traffic for the remote communication device for an emergency service.

In some embodiments, the remote communication device lacks a universal integrated circuit card, or subscriber identity module, for storing a subscription identity associated with the remote communication device.

In some embodiments, the relay communication device is a Layer-3 UE-to-Network Relay or a 5G Proximity Services, ProSe, UE-to-Network Relay.

In some embodiments, the remote communication device is a 5G ProSe Remote User Equipment.

Embodiments herein also include corresponding apparatus, computer programs, and carriers of those computer programs.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a communication network according to some embodiments.

FIG. 2 is a block diagram of a 5G network according to some embodiments for UE-to-network relaying.

FIG. 3 is a call flow diagram of security for UE-to-Network Relays according to some embodiments.

FIG. 4 is a call flow diagram of security for UE-to-Network Relays according to other embodiments.

FIG. 5 is a call flow diagram of some embodiments herein for identification of a remote communication device.

FIG. 6 is a logic flow diagram of a method performed by a relay communication device according to some embodiments.

FIG. 7 is a logic flow diagram of a method performed by a remote communication device according to some embodiments.

FIG. 8 is a logic flow diagram of a method performed by a network node according to some embodiments.

FIG. 9 is a block diagram of a communication device according to some embodiments.

FIG. 10 is a block diagram of a network node according to some embodiments.

FIG. 11 shows an example of a communication system in accordance with some embodiments.

FIG. 12 is a block diagram of a host which may be an embodiment of the host of FIG. 11, in accordance with various aspects described herein.

FIG. 13 shows a communication diagram of a host communicating via a network node with a UE over a partially wireless connection in accordance with some embodiments.

### DETAILED DESCRIPTION

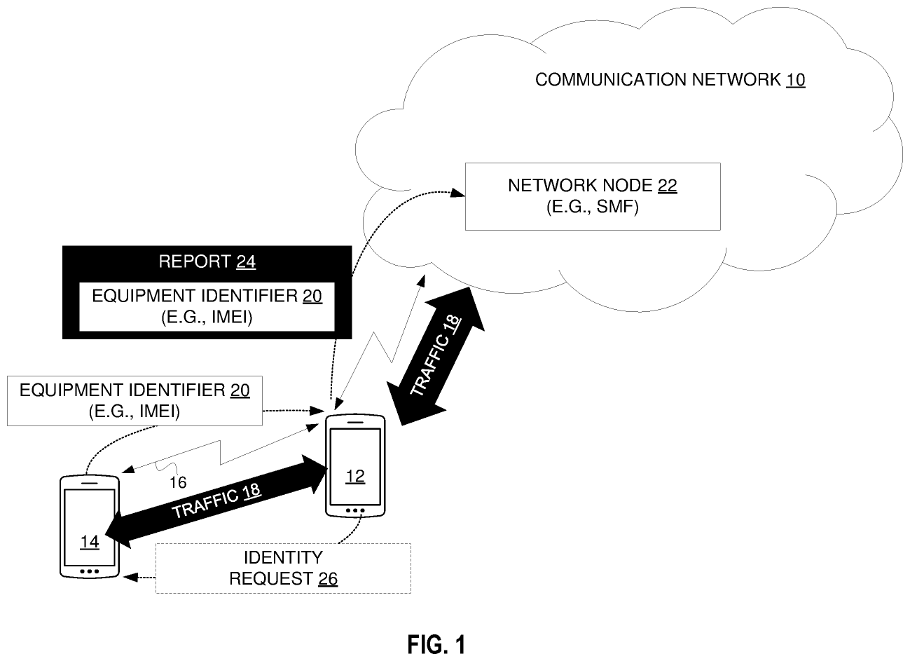

FIG. 1 shows proximity services (ProSe) relaying according to some embodiments. As shown, communication devices 12, 14 are in proximity of one another and communicate directly over an interface 16, e.g., a PC5 interface as defined according to 3GPP standards. Communicating directly over interface 16, communication devices 12, 14 communicate via a path that does not traverse any network node in a communication network 10. The communication devices 12, 14 exploit this proximity services direct communication in such a way that communication device 12 can relay traffic 18 for communication device 14, e.g., at layer 2 or layer 3 of the devices' protocol stack. Communication device 12 is accordingly referred to as a relay communication device 12, e.g., in the form of a Layer-3 UE-to-Network Relay or a 5G ProSe UE-to-Network Relay. And communication device 14 is referred to as a remote communication device 14, e.g., in the form of a 5G ProSe Remote User Equipment. In one embodiment as shown, for instance, the relay communication device 12 relays traffic 18 between the remote communication device 14 and the communication network 10. Via the relay communication device 12, then, the remote communication device 14 can communicate with the communication network 10 even if the remote communication device 14 is outside of (i.e., remote to) the network's coverage.

Some embodiments herein exploit an equipment identifier 20 associated with the remote communication device 14 for identifying the remote communication device 14 in this context. The equipment identifier 20 may identify the remote communication device 14 separate and apart from a subscription to receive communication services. The equipment identifier 20 may for instance be a Permanent Equipment Identifier (PEI), e.g., in the form of an International Mobile Equipment Identity (IMEI) or an IMEI Software Version (IMEISV).

As shown in this regard, the remote communication device 14 transmits the equipment identifier 20 to the relay communication device 12. In some embodiments, the remote communication device 14 transmits the equipment identifier 20 in a request (e.g., a Direct Communication Request, DCR) for the relay communication device 12 to relay traffic for the remote communication device 14. In other embodiments, the remote communication device 14 transmits the equipment identifier 20 in a response to an identity request 26 from the relay communication device 12 requesting information identifying the remote communication device 14, e.g., where the identity request 26 may be a Remote Identity Request or may be included in a Direct Security Mode Command message. In one such embodiment, the relay communication device 12 makes a decision to transmit the identity request 26 to the remote communication device 14 if the relay communication device 12 receives a request to relay traffic but the request lacks the equipment identifier 20.

Regardless, in receipt of such an equipment identifier 20, the relay communication device 12 may report the equipment identifier 20 to a network node 22 in the communication network 10, e.g., a network node implementing a Session Management Function (SMF). FIG. 1 on this point shows that the relay communication device 12 transmits a report 24 to the network node 22, e.g., a Remote User Equipment Report. This report 24 reports the equipment identifier 20 as identifying the remote communication device 14 for which the relay communication device 12 is to relay traffic 18. The network node 22 may then use the equipment identifier 20 to identify the remote communication device 14 and/or to determine that the remote communication device 14 has an ongoing session.

By exploiting such an equipment identifier 20, some embodiments advantageously provide more robust support for emergency service traffic relaying. Indeed, in some embodiments, the equipment identifier 20 herein is available even if the remote communication device 14 lacks an integrated circuit card, or subscriber identity module, for storing a subscription identity (e.g., an International Mobile Subscription Identity, IMSI) identifying a subscription associated with the remote communication device 14. And the equipment identifier 20 is moreover available even if the remote communication device 14 cannot be authenticated. Accordingly, even if the remote communication device 14 lacks an integrated circuit card or subscriber identity module, and even if the remote communication device 14 cannot be authenticated, some embodiments still enable identification of the remote communication device 14 so as to still support emergency service traffic relaying in this case.

Some embodiments herein then are implemented as part of, in order for, or conditional upon the relay communication device 12 relaying traffic for the remote communication device 14 for an emergency service. For example, in some embodiments, the remote communication device 14 transmits the equipment identifier 20 to the relay communication device 12 based on the traffic 18 being for an emergency service and/or based on transmitting an emergency relay service code (RSC). The remote communication device 14 may for example transmit the equipment identifier 20 in a request (e.g., a Direct Communication Request, DCR) for the relay communication device 12 to relay traffic for the remote communication device 14 for an emergency service, e.g., in which case the request may include an emergency relay service code (RSC). In one such embodiment, though, the remote communication device 14 transmits the equipment identifier 20 to the relay communication device 12 in this case only if the remote communication device 14 lacks an integrated circuit card or subscriber identity module, and/or if the remote communication device 14 cannot be authenticated, i.e., if the remote communication device 14 is unable to provide a proximity services relay user key (PRUK) identity or subscription identity.

Consider now an example of some embodiments herein where the relay communication device 12 is a 5G ProSe UE-to-Network Relay and the remote communication device 14 is a 5G ProSe Remote User Equipment (UE).

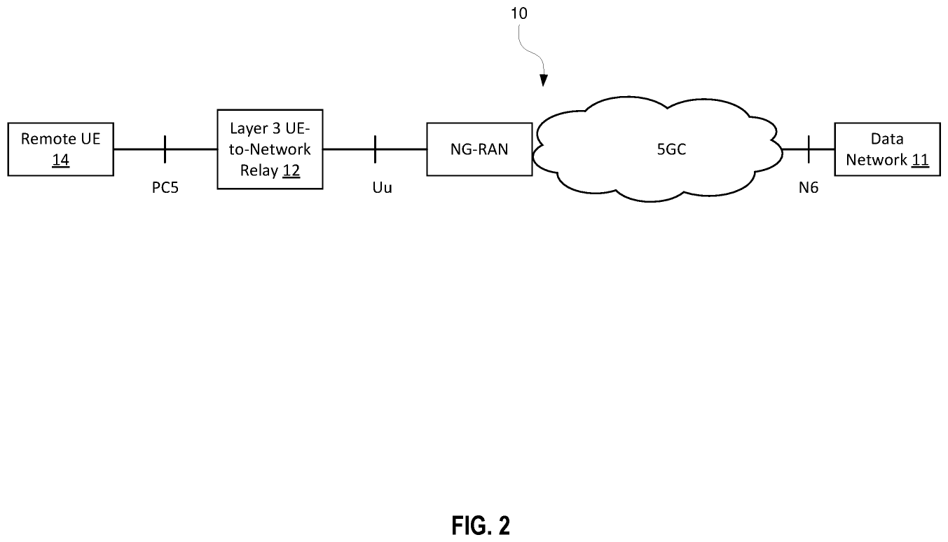

A 5G ProSe UE-to-Network Relay is a (5G ProSe-enabled) UE that provides functionality to support connectivity to the network for 5G ProSe Remote UE(s). FIG. 2 shows the reference architecture for a 5G ProSe Layer-3 UE-to-Network Relay according to some embodiments where the communication network 10 is a 5G network comprised of a Next Generation (NG) Radio Access Network (NG-RAN) and a 5G Core (5GC), with the 5GC providing access to a data network 11, e.g., the Internet. As shown, the relay communication device 12 is in the form of a 5G ProSe Layer-3 UE-to-Network Relay.

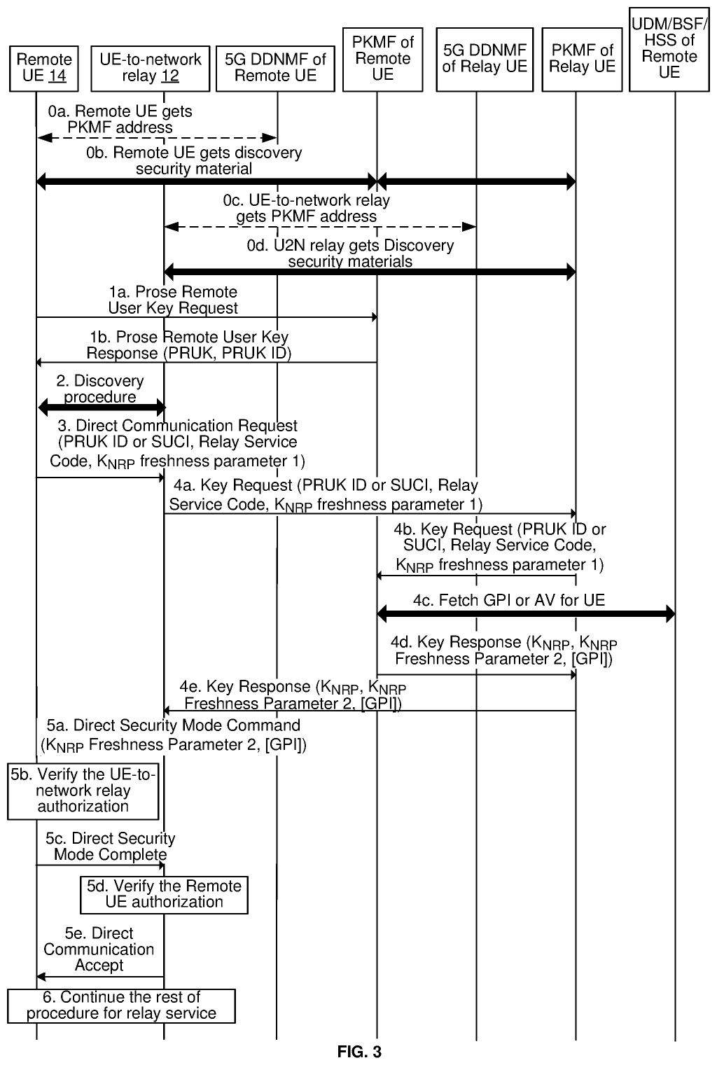

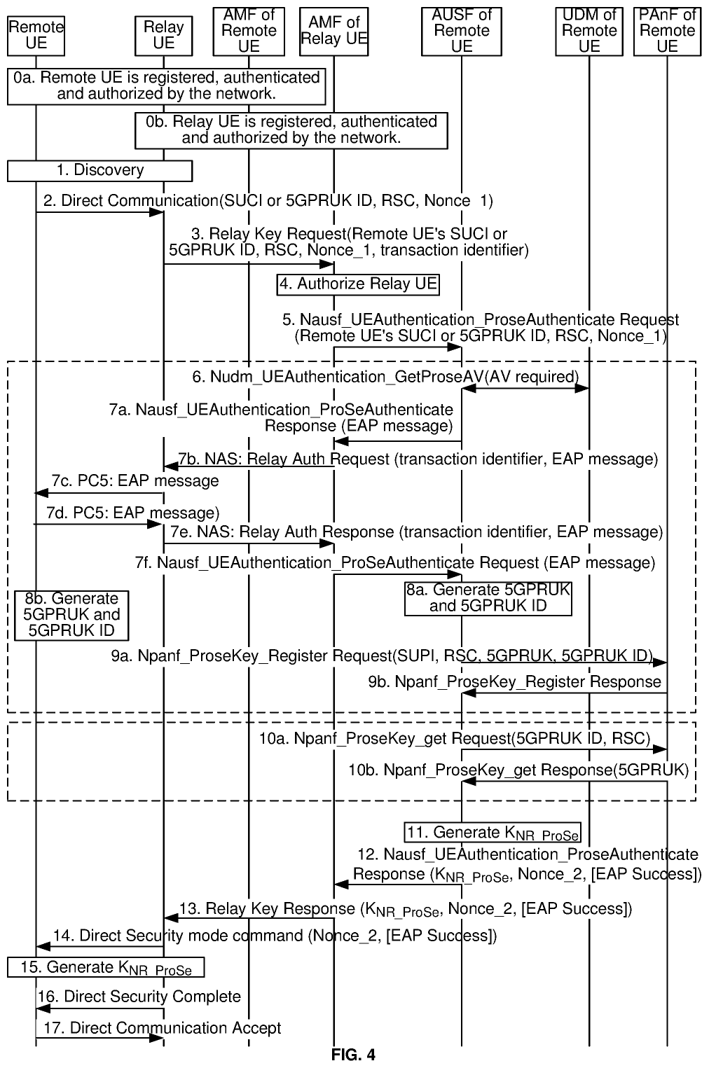

Some embodiments herein are applicable to the procedure of Security for 5G ProSe Communication via 5G ProSe Layer-3 UE-to-Network Relay, as otherwise specified by TS 33.503 V17.1.0. Embodiments herein are applicable to either or both methods i.e., user-plane (UP) based and control-plane (CP) based procedures. Both can be used for 5G ProSe UE-to-Network Relay authorization and security establishment in PC5 interface. The UP based procedure as shown in FIG. 3 uses a UP connection to the 5G ProSe Key Management Function (PKMF) in the 5G Core (5GC), while the CP based procedure shown in FIG. 4 uses the ProSe authentication vehicle over non-access stratum (NAS) procedure towards Access and Mobility Function (AMF), Authentication Server Function (AUSF) in the 5GC. Details of the steps of FIG. 3 are found in TS 33.503 V17.1.0 Section 6.3.3.2.2, and details of the steps of FIG. 4 are found in TS 33.503 V17.1.0 Section 6.3.3.3.2.

Some embodiments herein may be incorporated into the high-level flows of security for UE-to-Network Relays as shown in FIGS. 3 and 4, except as otherwise specified herein.

Some embodiments herein in this regard support emergency service over UE-to-Network Relay, e.g., per TS23.700-33 V1.0.0,

According to TS 22.101, emergency service is defined as citizen to authority services, and it is left to the national authorities to decide whether the network accepts emergency calls e.g. for valid UE only, or for UEs without the SIM/USIM/ISIM. Here, ISIM stands for Internet Protocol (IP) Multimedia Services Identity Module.

In the 5G ProSe UE-to-Network relaying, if there is an emergency request from the remote UE, it implies that the Relay UE needs to be responsible for remote UE's emergency service. It is required that the Relay UE has a valid SIM/USIM/ISIM.

In some embodiments, the Relay UE shall support to establish PC5 communication for emergency service, for either an authenticated Remote UE (e.g. Remote UE with USIM and properly being authenticated by PC5 communication security procedure) or an unauthenticated Remote UE (e.g. Remote UE without USIM or authentication can't complete for any reason).

Some embodiments herein specify a procedure to setup the emergency session and the security thereof.

In particular, some embodiments herein propose that a normal PC5 communication security procedure for emergency service is performed for a valid Remote User ID. By contrast, in some embodiments, a PC5 communication security with null ciphering and integrity is performed for an unauthenticated Remote UE.

With regard to reporting for an emergency service, in some embodiments, an authenticated Remote User ID, i.e. (UP-/CP-) PRUK ID or SUbscription Concealed Identifier (SUCI), is used as UE ID for an authenticated remote UE. By contrast, in case of an unauthenticated Remote UE, a PEI in some embodiments is used to identify the UE in a Remote UE Report. Some embodiments herein therefore include one or more methods to retrieve the PEI of the remote UE over the PC5 link.

Certain embodiments may provide one or more of the following technical advantage(s). Some embodiments allow PC5 communication establishment and reporting for unauthenticated UEs.

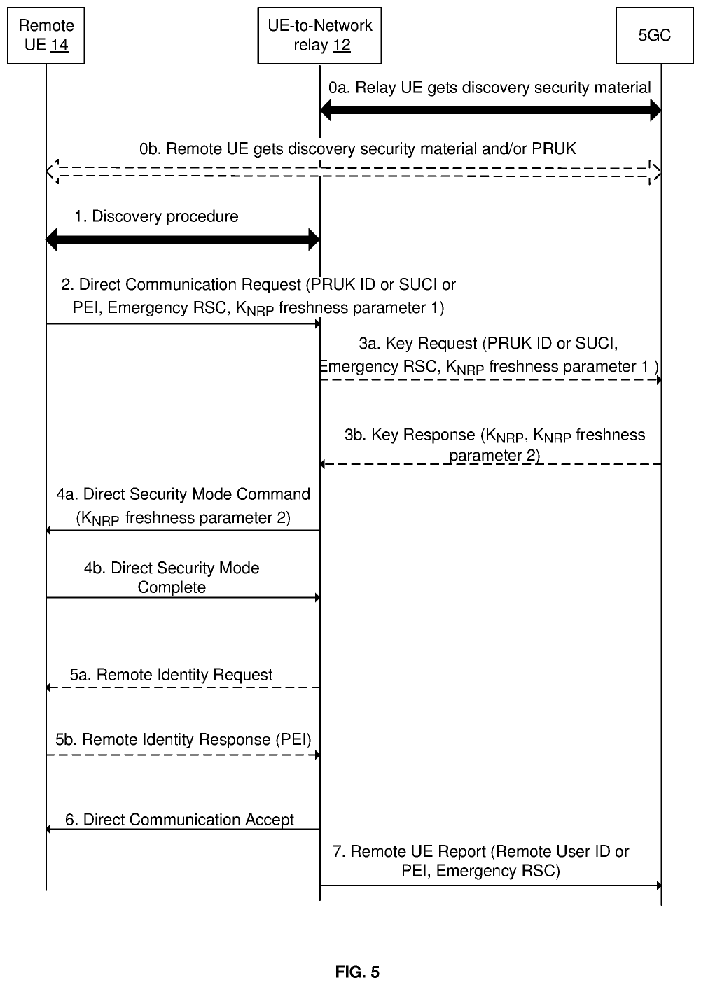

FIG. 5 shows a call flow diagram of some embodiments herein where the relay communication device 12 in FIG. 1 is exemplified as a 5G ProSe UE-to-Network relay, the remote communication device 14 in FIG. 1 is exemplified as a 5G ProSe Remote UE, the traffic 18 is exemplified as traffic for an emergency service, and the equipment identifier 20 is exemplified as a PEI.

Step 0a. The 5G ProSe UE-to-Network relay 12 is provisioned with the discovery security materials as described in TS 33.503 V17.1.0. Based on the local regulation and the operator policy, there may or may not be discovery security materials provisioned for Emergency Relay Service Code (RSC).

Step 0b. The 5G ProSe Remote UE 14 is provisioned with the discovery security materials and retrieves the UP-PRUK and UP-PRUK ID for UP based security method from the network as described in TS 33.503 V17.1.0. Based on the local regulation and the operator policy, there may be or may be no discovery security materials provisioned for Emergency RSC.

If the 5G ProSe Remote UE is USIM-less, this step is skipped. The Emergency RSC and the discovery security materials (if exist) are locally configured in the 5G ProSe Remote UE 14.

Step 1. The discovery procedure for the Emergency RSC is performed between the 5G ProSe Remote UE 14 and the 5G ProSe UE-to-Network Relay 12 using the discovery parameters and discovery security material as described in TS 33.503 V17.1.0.

Based on the local regulation and the operator policy, the announcement and discovery of Emergency RSC may be performed without security protection.

Step 2. If the 5G ProSe Remote UE 14 has USIM, the 5G ProSe Remote UE 14 sends a Direct Communication Request (DCR) that contains (UP-/CP-) PRUK ID or SUCI, Emergency RSC and K_{NRP} freshness parameter 1 to the 5G ProSe UE-to-Network Relay 12. The message may additionally include the PEI of the 5G ProSe Remote UE 14.

If the 5G ProSe Remote UE 14 is USIM-less, the 5G ProSe Remote UE 14 sends a Direct Communication Request that contains PEI and Emergency RSC to the 5G ProSe UE-to-Network Relay 12. In this way, the 5G ProSe Remote UE 14 may send the 5G ProSe UE-to-Network Relay 12 its equipment identifier 20 as shown in FIG. 1, where the equipment identifier 20 is exemplified as the PEI.

Step 3, composed of Steps 3a and 3b. If (UP-/CP-) PRUK ID or SUCI is received, the 5G ProSe UE-to-Network Relay 12 performs UP or CP based security procedure as described in TS33.503 V17.1.0. This includes the 5G ProSe UE-to-Network Relay 12 transmitting a key request to the 5GC (Step 3a) and receiving a key response from the 5GC, including the requested key (Step 3b).

If only PEI and Emergency RSC are received, the 5G ProSe UE-to-Network Relay 12 skips this step if the local regulation and the operator policy allow.

Step 4, composed of Steps 4a and 4b. If step 3 is successfully performed, the 5G ProSe UE-to-Network Relay 12 performs Direct Security Mode Command procedure towards the 5G ProSe Remote UE 13 as described in TS33.503 V17.1.0. This includes the 5G ProSe UE-to-Network Relay 12 transmitting a Direct Security Mode Command towards the 5G ProSe Remote UE 13 (Step 4a) and receiving a Direct Security Mode Complete from the 5G ProSe Remote UE 13 (Step 4b).

If step 3 is failed or skipped, e.g., the 5G ProSe Remote UE 13 is USIM-less, the 5G ProSe UE-to-Network Relay 12 performs Direct Security Mode Command procedure with Null ciphering and integrity protection if the local regulation and the operator policy allow.

In the message, there may be included a flag to indicate the chosen algorithm for Null ciphering and integrity protection. Null ciphering and integrity protection may be achieved by setting PC5 link root key or session keys to a specific value e.g., all zeros.

In the message, there may be included an indicator e.g., “PEI request” to request PEI (e.g., IMEI) from the remote UE 14.

Step 5, composed of Steps 5a and 5b. If the 5G ProSe Remote UE 14 is not authenticated successfully via UP or CP based security procedure (step 3 fails or skipped) or Direct Security Mode Command procedure (step 4) failed or skipped, and PEI is not received from Direct Communication Request, the 5G ProSe UE-to-Network Relay 12 sends Remote Identity Request to the 5G ProSe Remote UE 14 (Step 5a) to retrieve the PEI based on the local regulation and the operator policy. Here, the Remote Identity Request exemplifies the identity request 26 in FIG. 1. The 5G ProSe Remote UE 14 returns a Remote Identity Response back to the 5G ProSe UE-to-Network Relay 12 (Step 5b).

Step 6. The 5G ProSe UE-to-Network Relay 12 sends a Direct Communication Accept message to the 5G ProSe Remote UE 14 to finish the PC5 connection establishment procedures for the emergency service.

Step 7. When the 5G ProSe Layer-3 UE-to-Network Relay 12 sends a Remote UE Report to the SMF for the Emergency RSC, the 5G ProSe Layer-3 UE-to-Network Relay 12 includes Remote User ID i.e. (UP-/CP-) PRUK ID if UP or CP based security procedure is successfully performed. Otherwise, the 5G ProSe Layer-3 UE-to-Network Relay 12 includes the PEI of the 5G ProSe Remote UE 14 in the Remote UE Report. Here, the Remote UE Report exemplifies the report 24 in FIG. 1.

In some embodiments herein, a Permanent Equipment Identifier (PEI) is defined for the 3GPP UE accessing the 5G System. The PEI can assume different formats for different UE types and use cases. The UE shall present the PEI to the network together with an indication of the PEI format being used. If the UE supports at least one 3GPP access technology (i.e. NG-RAN, E-UTRAN, UTRAN or GERAN), the UE must be allocated a PEI in the IMEI or IMEISV format. If a UE has registered with a network by using a network subscription and a PEI of the UE, then the UE shall keep the PEI to be used with the network subscription and shall not use that PEI with another network subscription while the UE is in registered state in the network.

In some embodiments, the PEI may be one of the following: (i) for UEs that support at least one 3GPP access technology, an IMEI or IMEISV, as defined in TS 23.003 v17.6.0; (ii) PEI used in the case of W-5GAN access as further specified in TS 23.316 v17.3.0; (iii) for UEs not supporting any 3GPP access technologies, the IEEE Extended Unique Identifier EUI-64 of the access technology the UE uses to connect to the 5GC.

In some embodiments, the Relay Service Code (RSC) is used in the 5G ProSe UE-to-Network Relay discovery, to indicate the connectivity service the 5G ProSe UE-to-Network Relay 12 provides to the 5G ProSe Remote UE 14. The RSCs are configured on the 5G ProSe UE-to-Network Relay 12 and the 5G ProSe Remote UE 14.

In some embodiments, an ‘Emergency call’ refers to speech calls, and Global Traffic Technologies (GTT) Emergency calls if applicable. Emergency calls will be routed to the emergency services in accordance with national regulations for where the subscriber is located. This may be based upon one or more default emergency call numbers stored in the mobile equipment (ME). It shall be allowed to establish an emergency call without the need to dial a dedicated number to avoid the mis-connection in roaming case, such as menu, by use of a ‘red button’, or a linkage to a car air bag control. Emergency calls shall be supported by the UE without a SIM/USIM/ISIM being present.

Emergency calls shall be supported by UEs that are subject to service restrictions, e.g. for UEs camping on a cell in a forbidden PLMN or in a forbidden Location Area (LA) (see 3GPP TS 22.011 v18.3.0), or on a Closed Subscriber Group (CSG) cell without the subscriber being a member of that CSG (see 3GPP TS 22.220 v17.0.0). Such emergency calls shall be accepted by the network if required by local regulation.

It shall be possible to initiate emergency calls to different emergency call centres, depending on the type of emergency. Some embodiments herein are applicable for one or more of following types of emergency calls: Police, Ambulance, Fire Brigade, Marine Guard, Mountain Rescue, Manually Initiated eCall (MleC), Automatically Initiated eCall (AleC)

The Home Environment operator shall specify preferred emergency call numbers (e.g. 999 for United Kingdom (UK) citizens or 110, 118 and 119 for Japanese citizens). These emergency call numbers shall be stored in the SIM/USIM and the ME shall read this and use any entry of these digits to set up an emergency call. It shall be possible to store more than one instance of this field.

It shall be possible to tie any emergency call number to any single emergency call type or to any combination of emergency call types. The association between emergency call numbers and emergency call type shall be able to be programmed by the Home Environment operator into the SIM/USIM.

The ME shall identify an emergency number dialled by the end user as a valid emergency number and initiate emergency call establishment if it occurs under one or more of the following conditions. If it occurs outside of the following conditions, the ME should not initiate emergency call establishment but normal call establishment. Emergency number identification takes place before and takes precedence over any other (e.g. supplementary service related) number analysis.
a) 112 and 911 shall always be available. These numbers shall be stored on the ME.
b) Any emergency call number stored on a SIM/USIM when the SIM/USIM is present.
c) 000, 08, 110, 999, 118 and 119 when a SIM/USIM is not present. These numbers shall be stored on the ME.
d) Additional emergency call numbers that may have been downloaded by the serving network when the SIM/USIM is present.

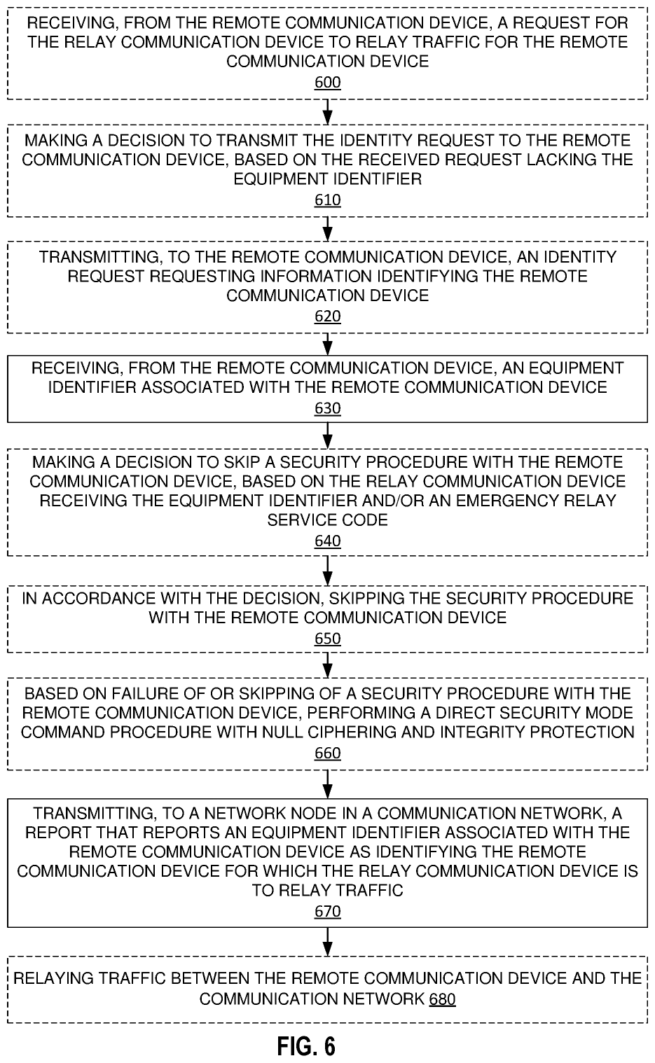

In view of the modifications and variations herein, FIG. 6 depicts a method performed by a relay communication device 12 configured to relay traffic 18 for a remote communication device 14 in accordance with particular embodiments. In one embodiment, for instance, the relay communication device 12 is to relay traffic 18 for the remote communication device 14 for an emergency service.

Regardless, the method in some embodiments includes receiving, from the remote communication device 14, an equipment identifier 20 associated with the remote communication device 14, e.g., a Permanent Equipment Identifier, PEI. (Block 630).

The method alternatively or additionally includes transmitting, to a network node 22 in a communication network 10, a report 24 that reports an equipment identifier 20 associated with the remote communication device 14 as identifying the remote communication device 14 for which the relay communication device 12 is to relay traffic 18 (Block 670). In some embodiments, the report is a Remote User Equipment Report. In some embodiments, the network node implements a Session Management Function, SMF.

In some embodiments, the method also comprises relaying traffic 18 between the remote communication device 12 and the communication network 10 (Block 680).

In some embodiments, the method comprises receiving the equipment identifier 20 and/or transmitting the report 24 reporting the equipment identifier 20, based on the traffic 18 being for an emergency service and/or based on receiving an emergency service relay code.

In some embodiments where the method comprises receiving the equipment identifier 20, the equipment identifier 20 may be received in a request for the relay communication device 12 to relay traffic 18 for the remote communication device 14. In some embodiments, the request is a Direct Communication Request, DCR. In some embodiments, the request requests the relay communication device 12 to relay traffic for the remote communication device 14 for an emergency service. In some embodiments, the request includes an emergency relay service code.

In other embodiments, though, if the request for the relay communication device 12 to relay traffic 18 for the remote communication device 14 lacks the equipment identifier 20 (Block 600), the method further comprises making a decision to transmit an identity request 26 to the remote communication device 14, based on the received request lacking the equipment identifier 20 (Block 610). According to this decision, then, the method further comprises transmitting, to the remote communication device 14, an identity request 26 requesting information identifying the remote communication device 14 (Block 620). In some embodiments, the identity request is a Remote Identity Request or is included in a Direct Security Mode Command message.

In some embodiments, the method further comprises making a decision to skip a security procedure with the remote communication device 14, based on the relay communication device 12 receiving the equipment identifier 20 and/or an emergency relay service code (Block 640). In one such embodiment, the method further comprises, in accordance with the decision, skipping the security procedure with the remote communication device 14 (Block 650). In some embodiments, the method further comprises, based on failure of or skipping of a security procedure with the remote communication device 14, performing a direct security mode command procedure with null ciphering and integrity protection (Block 660). In some embodiments, performing the direct security mode command procedure includes transmitting a message of the direct security mode command procedure with a flag indicating an algorithm chosen for the null ciphering and integrity protection. In some embodiments, performing the direct security mode command procedure includes setting a root key to a value specific for null ciphering and integrity protection and/or setting each of one or more session keys to a value specific for null ciphering and integrity protection.

In some embodiments, the equipment identifier is an International Mobile Equipment Identity, IMEI, or an IMEI Software Version, IMEISV.

In some embodiments, the relay communication device 12 is to relay traffic for the remote communication device for an emergency service.

In some embodiments, the remote communication device 14 lacks a universal integrated circuit card, or subscriber identity module, for storing a subscription identity associated with the remote communication device 14.

In some embodiments, the relay communication device 12 is a Layer-3 UE-to-Network Relay or a 5G Proximity Services, ProSe, UE-to-Network Relay.

In some embodiments, the remote communication device 14 is a 5G ProSe Remote User Equipment.

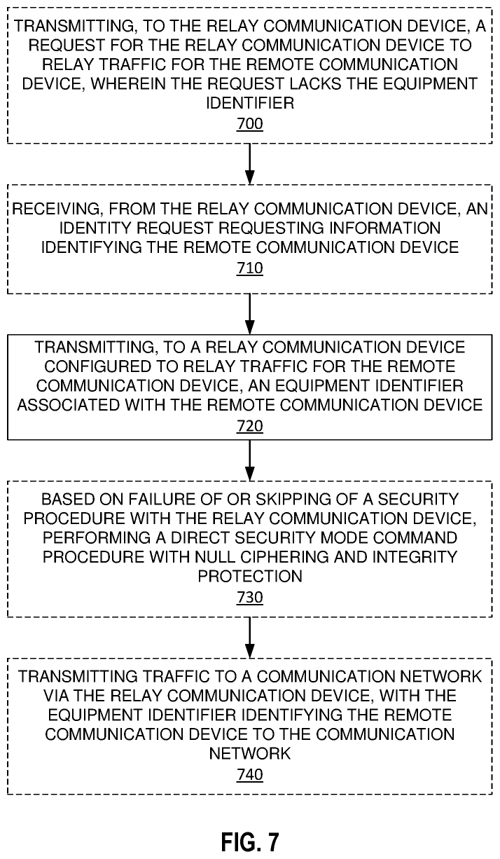

FIG. 7 depicts a method performed by a remote communication device 14 in accordance with other particular embodiments. The method includes transmitting, to a relay communication device 12 configured to relay traffic 18 for the remote communication device 14, an equipment identifier 20 associated with the remote communication device 14 (Block 720). For example, in one embodiment, the method comprises transmitting the equipment identifier 20, based on the traffic 18 being for an emergency service and/or based on transmitting an emergency service relay code.

In some embodiments, the method further comprises transmitting traffic 18 to a communication network 10 via the relay communication device 12, with the equipment identifier 20 identifying the remote communication device 14 to the communication network 10 (Block 740).

In some embodiments, the equipment identifier 20 is transmitted in a request for the relay communication device 12 to relay traffic for the remote communication device 14. In some embodiments, the request is a Direct Communication Request, DCR. In some embodiments, the request requests the relay communication device 12 to relay traffic for the remote communication device 14 for an emergency service. In some embodiments, the request includes an emergency relay service code.

In other embodiments, the method further comprises transmitting, to the relay communication device 12, a request for the relay communication device 12 to relay traffic 18 for the remote communication device 14, wherein the request lacks the equipment identifier 20 (Block 700). In one such embodiment, the method further comprises receiving, from the relay communication device 12, an identity request 26 requesting information identifying the remote communication device 14 (Block 710). In some embodiments, the identity request is a Remote Identity Request or is included in a Direct Security Mode Command message. In some embodiments, the equipment identifier is transmitted in response to the identity request.

In some embodiments, the equipment identifier 20 is a Permanent Equipment Identifier, PEI.

In some embodiments, the equipment identifier 20 is an International Mobile Equipment Identity, IMEI, or an IMEI Software Version, IMEISV.

In some embodiments, the relay communication device 12 is to relay traffic for the remote communication device 14 for an emergency service.

In some embodiments, the method further comprises transmitting the equipment identifier 20, based on the traffic 18 being for an emergency service and/or based on transmitting an emergency service relay code.

In some embodiments, the remote communication device 14 lacks a universal integrated circuit card, or subscriber identity module, for storing a subscription identity associated with the remote communication device 14.

In some embodiments, the method further comprises, based on failure of or skipping of a security procedure with the relay communication device 12, performing a direct security mode command procedure with null ciphering and integrity protection (Block 730). In some embodiments, performing the direct security mode command procedure includes receiving a message of the direct security mode command procedure with a flag indicating an algorithm chosen for the null ciphering and integrity protection. In some embodiments, performing the direct security mode command procedure includes setting a root key to a value specific for null ciphering and integrity protection and/or setting each of one or more session keys to a value specific for null ciphering and integrity protection.

In some embodiments, the relay communication device 12 is a Layer-3 UE-to-Network Relay or a 5G Proximity Services, ProSe, UE-to-Network Relay.

In some embodiments, the remote communication device 14 is a 5G ProSe Remote User Equipment.

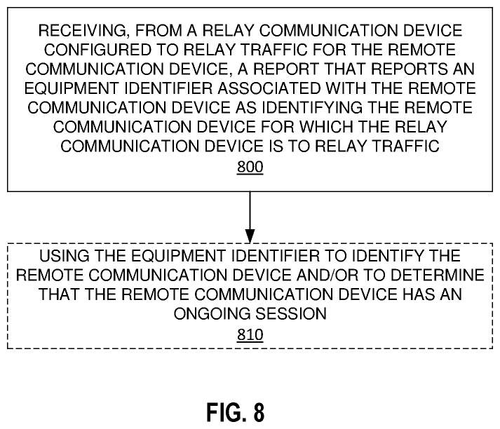

FIG. 8 depicts a method performed by a network node 22 in a communication network 10 in accordance with other particular embodiments. The method includes receiving, from a relay communication device 12 configured to relay traffic 18 for the remote communication device 14, a report 24 that reports an equipment identifier 20 associated with the remote communication device 14 as identifying the remote communication device 14 for which the relay communication device 12 is to relay traffic 18 (Block 800).

In some embodiments, the method further comprises using the equipment identifier 20 to identify the remote communication device 14 and/or to determine that the remote communication device 14 has an ongoing session (Block 810).

In some embodiments, the report 24 is a Remote User Equipment Report.

In some embodiments, the network node 22 implements a Session Management Function, SMF.

In some embodiments, the equipment identifier 20 is a Permanent Equipment Identifier, PEI.

In some embodiments, the equipment identifier 20 is an International Mobile Equipment Identity, IMEI, or an IMEI Software Version, IMEISV.

In some embodiments, the relay communication device 12 is to relay traffic for the remote communication device 14 for an emergency service.

In some embodiments, the remote communication device 14 lacks a universal integrated circuit card, or subscriber identity module, for storing a subscription identity associated with the remote communication device 14.

In some embodiments, the relay communication device 12 is a Layer-3 UE-to-Network Relay or a 5G Proximity Services, ProSe, UE-to-Network Relay.

In some embodiments, the remote communication device 14 is a 5G ProSe Remote User Equipment.

Embodiments herein also include corresponding apparatuses. Embodiments herein for instance include a communication device configured to perform any of the steps of any of the embodiments described above for the relay communication device 12 or the remote communication device 14.

Embodiments also include a communication device comprising processing circuitry and power supply circuitry. The processing circuitry is configured to perform any of the steps of any of the embodiments described above for the communication device. The power supply circuitry is configured to supply power to the relay communication device 12 or the remote communication device 14.

Embodiments further include a communication device comprising processing circuitry. The processing circuitry is configured to perform any of the steps of any of the embodiments described above for the relay communication device 12 or the remote communication device 14. In some embodiments, the communication device further comprises communication circuitry.

Embodiments further include a communication device comprising processing circuitry and memory. The memory contains instructions executable by the processing circuitry whereby the communication device is configured to perform any of the steps of any of the embodiments described above for the relay communication device 12 or the remote communication device 14.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the relay communication device 12 or the remote communication device 14. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 22 configured to perform any of the steps of any of the embodiments described above for the network node 22.

Embodiments also include a network node 22 comprising processing circuitry and power supply circuitry. The processing circuitry is configured to perform any of the steps of any of the embodiments described above for the network node 22. The power supply circuitry is configured to supply power to the network node 22.

Embodiments further include a network node 22 comprising processing circuitry. The processing circuitry is configured to perform any of the steps of any of the embodiments described above for the network node 22. In some embodiments, the network node 22 further comprises communication circuitry.

Embodiments further include a network node 22 comprising processing circuitry and memory. The memory contains instructions executable by the processing circuitry whereby the network node 22 is configured to perform any of the steps of any of the embodiments described above for the network node 22.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

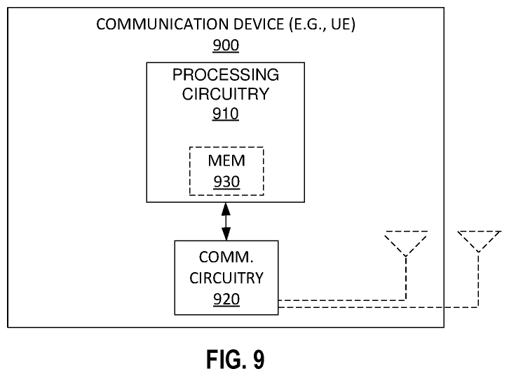

FIG. 9 for example illustrates a communication device 900 as implemented in accordance with one or more embodiments. The communication device 900 may for instance be the relay communication device 12 or the remote communication device 14. As shown, the communication device 900 includes processing circuitry 910 and communication circuitry 920. The communication circuitry 920 (e.g., radio circuitry) is configured to transmit and/or receive information to and/or from one or more other nodes, e.g., via any communication technology. Such communication may occur via one or more antennas that are either internal or external to the communication device 900. The processing circuitry 910 is configured to perform processing described above, e.g., in FIG. 6 or 7, such as by executing instructions stored in memory 930. The processing circuitry 910 in this regard may implement certain functional means, units, or modules.

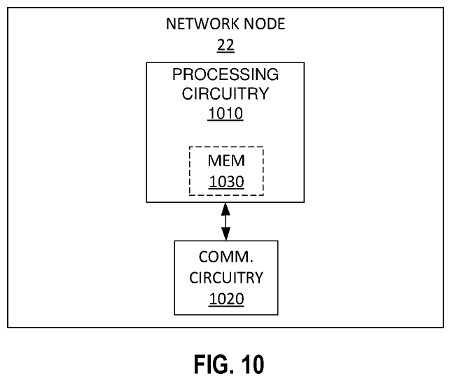

FIG. 10 illustrates a network node 22 as implemented in accordance with one or more embodiments. As shown, the network node 22 includes processing circuitry 1010 and communication circuitry 1020. The communication circuitry 1020 is configured to transmit and/or receive information to and/or from one or more other nodes, e.g., via any communication technology. The processing circuitry 1010 is configured to perform processing described above, e.g., in FIG. 8, such as by executing instructions stored in memory 1030. The processing circuitry 1010 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

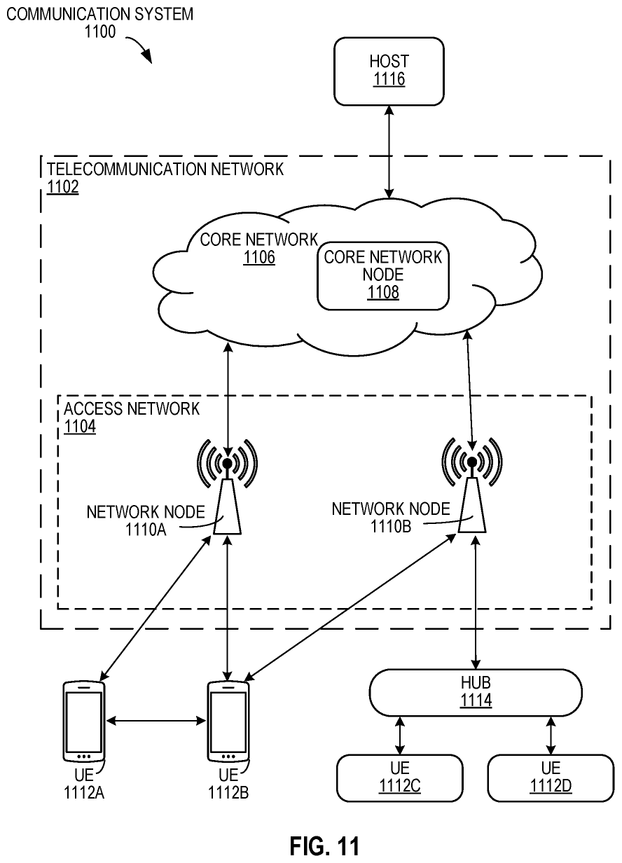

FIG. 11 shows an example of a communication system 1100 in accordance with some embodiments.

In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3^{rd} Generation Partnership Project (3GPP) access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

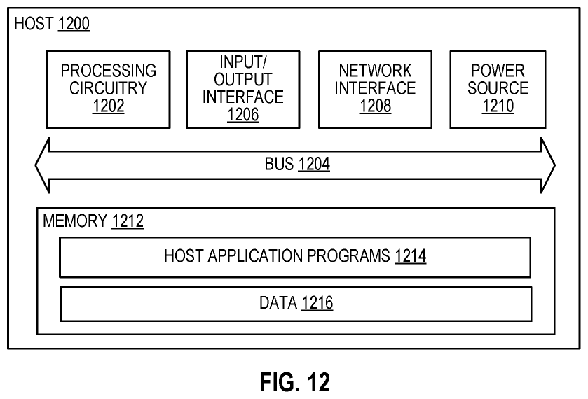

FIG. 12 is a block diagram of a host 1200, which may be an embodiment of the host 1116 of FIG. 11, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

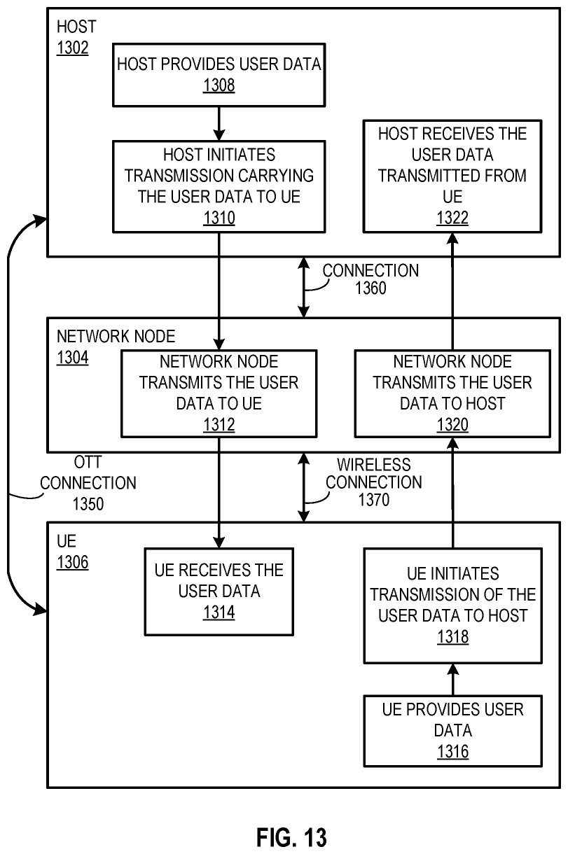

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 12 and 13, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1200 of FIG. 12) discussed in the preceding paragraphs will now be described with reference to FIG. 13.

Like host 1200, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 1106 of FIG. 11) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the present disclosure will come to mind to one skilled in the art having the benefit of the teachings presented in the foregoing descriptions and the associated drawings. Therefore, it is to be understood that the present disclosure is not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a relay communication device configured to relay traffic for a remote communication device, the method comprising:
receiving, from the remote communication device, an equipment identifier associated with the remote communication device; and/or
transmitting, to a network node in a communication network, a report that reports an equipment identifier associated with the remote communication device as identifying the remote communication device for which the relay communication device is to relay traffic.
   A2. The method of embodiment A1, comprising receiving the equipment identifier.
   A3. The method of embodiment A2, wherein the equipment identifier is received in a request for the relay communication device to relay traffic for the remote communication device.
   A4. The method of embodiment A3, wherein the request is a Direct Communication Request, DCR.
   A5. The method of any of embodiments A3-A4, wherein the request requests the relay communication device to relay traffic for the remote communication device for an emergency service.
   A6. The method of any of embodiments A3-A5, wherein the request includes an emergency relay service code.
   A7. The method of embodiment A2, further comprising transmitting, to the remote communication device, an identity request requesting information identifying the remote communication device, wherein the equipment identifier is received in response to the identity request.
   A8. The method of embodiment A7, further comprising:
receiving, from the remote communication device, a request for the relay communication device to relay traffic for the remote communication device; and
making a decision to transmit the identity request to the remote communication device, based on the received request lacking the equipment identifier;
wherein the identity request is transmitted according to the decision.
   A9. The method of embodiment A8, wherein the identity request is a Remote Identity Request or is included in a Direct Security Mode Command message.
   A10. The method of any of embodiments A1-A9, comprising transmitting the report.
   A11. The method of embodiment A10, wherein the report is a Remote User Equipment Report.

A12. The method of any of embodiments A10-A11, wherein the network node implements a Session Management Function, SMF.

A13. The method of any of embodiments A1-A12, wherein the equipment identifier is a Permanent Equipment Identifier, PEI.
A14. The method of any of embodiments A1-A13, wherein the equipment identifier is an International Mobile Equipment Identity, IMEI, or an IMEI Software Version, IMEISV.
A15. The method of any of embodiments A1-A14, wherein the relay communication device is to relay traffic for the remote communication device for an emergency service.
A16. The method of any of embodiments A1-A15, further comprising receiving the equipment identifier and/or transmitting the report reporting the equipment identifier, based on the traffic being for an emergency service and/or based on receiving an emergency service relay code.
A17. The method of any of embodiments A1-A16, wherein the remote communication device lacks a universal integrated circuit card, or subscriber identity module, for storing a subscription identity associated with the communication device.
A18. The method of any of embodiments A1-A17, further comprising:
making a decision to skip a security procedure with the remote communication device, based on the relay communication device receiving the equipment identifier and/or an emergency relay service code; and
in accordance with the decision, skipping the security procedure with the remote communication device.
   A19. The method of any of embodiments A1-A18, further comprising, based on failure of or skipping of a security procedure with the remote communication device, performing a direct security mode command procedure with null ciphering and integrity protection.
   A20. The method of embodiment A19, wherein performing the direct security mode command procedure includes transmitting a message of the direct security mode command procedure with a flag indicating an algorithm chosen for the null ciphering and integrity protection.
   A21. The method of any of embodiments A19-A20, wherein performing the direct security mode command procedure includes setting a root key to a value specific for null ciphering and integrity protection and/or setting each of one or more session keys to a value specific for null ciphering and integrity protection.
   A22. The method of any of embodiments A1-A21, wherein the relay communication device is a Layer-3 UE-to-Network Relay or a 5G Proximity Services, ProSe, UE-to-Network Relay.
   A23. The method of any of embodiments A1-A22, wherein the remote communication device is a 5G ProSe Remote User Equipment.
   AA1. A method performed by a remote communication device, the method comprising: transmitting, to a relay communication device configured to relay traffic for the remote communication device, an equipment identifier associated with the remote communication device.

### AA2. Reserved.

AA3. The method of embodiment AA1, wherein the equipment identifier is transmitted in a request for the relay communication device to relay traffic for the remote communication device.
AA4. The method of embodiment AA3, wherein the request is a Direct Communication Request, DCR.
AA5. The method of any of embodiments AA3-AA4, wherein the request requests the relay communication device to relay traffic for the remote communication device for an emergency service.
AA6. The method of any of embodiments AA3-AA5, wherein the request includes an emergency relay service code.
AA7. The method of embodiment AA, further comprising receiving, from the relay communication device, an identity request requesting information identifying the remote communication device, wherein the equipment identifier is transmitted in response to the identity request.
AA8. The method of embodiment AA7, further comprising transmitting, to the relay communication device, a request for the relay communication device to relay traffic for the remote communication device, wherein the request lacks the equipment identifier, wherein the identity request is received after transmitting the request.
AA9. The method of embodiment AA8, wherein the identity request is a Remote Identity Request or is included in a Direct Security Mode Command message.
AA10. The method of any of embodiments AA1-AA9, wherein the equipment identifier is a Permanent Equipment Identifier, PEI.
AA11. The method of any of embodiments AA1-AA13, wherein the equipment identifier is an International Mobile Equipment Identity, IMEI, or an IMEI Software Version, IMEISV.
AA12. The method of any of embodiments AA1-AA11, wherein the relay communication device is to relay traffic for the remote communication device for an emergency service.
AA13. The method of any of embodiments AA1-AA12, further comprising transmitting the equipment identifier, based on the traffic being for an emergency service and/or based on transmitting an emergency service relay code.
AA14. The method of any of embodiments AA1-AA13, wherein the remote communication device lacks a universal integrated circuit card, or subscriber identity module, for storing a subscription identity associated with the communication device.
AA15. The method of any of embodiments AA1-AA14, further comprising, based on failure of or skipping of a security procedure with the relay communication device, performing a direct security mode command procedure with null ciphering and integrity protection.
AA16. The method of embodiment AA15, wherein performing the direct security mode command procedure includes receiving a message of the direct security mode command procedure with a flag indicating an algorithm chosen for the null ciphering and integrity protection.
AA17. The method of any of embodiments AA15-AA16, wherein performing the direct security mode command procedure includes setting a root key to a value specific for null ciphering and integrity protection and/or setting each of one or more session keys to a value specific for null ciphering and integrity protection.
AA18. The method of any of embodiments AA1-AA17, wherein the relay communication device is a Layer-3 UE-to-Network Relay or a 5G Proximity Services, ProSe, UE-to-Network Relay.
AA19. The method of any of embodiments AA1-AA18, wherein the remote communication device is a 5G ProSe Remote User Equipment.
AA. The method of any of the previous embodiments, further comprising:
providing user data; and
forwarding the user data to a host computer via the transmission to a base station.

### Group B Embodiments

B1. A method performed by a network node in a communication network, the method comprising:
receiving, from a relay communication device configured to relay traffic for the remote communication device, a report that reports an equipment identifier associated with the remote communication device as identifying the remote communication device for which the relay communication device is to relay traffic.
   B2. The method of embodiment B1, further comprising using the equipment identifier to identify the remote communication device and/or to determine that the remote communication device has an ongoing session.
   B3. The method of any of embodiments B1-B2, wherein the report is a Remote User Equipment Report.
   B4. The method of any of embodiments B1-B3, wherein the network node implements a Session Management Function, SMF.
   B5. The method of any of embodiments B1-B4, wherein the equipment identifier is a Permanent Equipment Identifier, PEI.
   B6. The method of any of embodiments B1-B5, wherein the equipment identifier is an International Mobile Equipment Identity, IMEI, or an IMEI Software Version, IMEISV.
   B7. The method of any of embodiments B1-B6, wherein the relay communication device is to relay traffic for the remote communication device for an emergency service.
   B8. The method of any of embodiments B1-B7, wherein the remote communication device lacks a universal integrated circuit card, or subscriber identity module, for storing a subscription identity associated with the remote communication device.
   B9. The method of any of embodiments B1-B8, wherein the relay communication device is a Layer-3 UE-to-Network Relay or a 5G Proximity Services, ProSe, UE-to-Network Relay.
   B10. The method of any of embodiments B1-B9, wherein the remote communication device is a 5G ProSe Remote User Equipment.
   BB. The method of any of the previous embodiments, further comprising:
obtaining user data; and
forwarding the user data to a host computer or a communication device.

### Group C Embodiments

C1. A communication device configured to perform the method of any of the Group A embodiments.
C2. A communication device comprising processing circuitry configured to perform the method of any of the Group A embodiments.
C3. A communication device comprising:
communication circuitry; and
processing circuitry configured to perform the method of any of the Group A embodiments.
   C4. A communication device comprising:
processing circuitry configured to perform the method of any of the Group A embodiments; and
power supply circuitry configured to supply power to the communication device.
   C5. A communication device comprising:
processing circuitry and memory, the memory containing instructions executable by the processing circuitry whereby the communication device is configured to perform the method of any of the Group A embodiments.
   C6. The communication device of any of embodiments C1-C5, wherein the communication device is a wireless communication device.
   C7. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform the method of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
   C8. A computer program comprising instructions which, when executed by at least one processor of a communication device, causes the communication device to perform the method of any of the Group A embodiments.
   C9. A carrier containing the computer program of embodiment C7, wherein the carrier is one of an electronic signal, optical signal, radio signal, or computer readable storage medium.
   C10. A network node configured to perform the method of any of the Group B embodiments.
   C11. A network node comprising processing circuitry configured to perform the method of any of the Group B embodiments.
   C12. A network node comprising:
communication circuitry; and
processing circuitry configured to perform the method of any of the Group B embodiments.
   C13. A network node comprising:
processing circuitry configured to perform the method of any of the Group B embodiments;
power supply circuitry configured to supply power to the network node.
   C14. A network node comprising:
processing circuitry and memory, the memory containing instructions executable by the processing circuitry whereby the network node is configured to perform the method of any of the Group B embodiments.
   C15. The network node of any of embodiments C10-C14, wherein the network node is a base station.
   C16. A computer program comprising instructions which, when executed by at least one processor of a network node, causes the network node to perform the method of any of the Group B embodiments.
   C17. The computer program of embodiment C16, wherein the network node is a base station.
   C18. A carrier containing the computer program of any of embodiments C16-C17, wherein the carrier is one of an electronic signal, optical signal, radio signal, or computer readable storage medium.

### Group D Embodiments

D1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the method of any of the Group B embodiments to transmit the user data from the host to the UE.
   D2. The host of the previous embodiment, wherein:
the processing circuitry of the host is configured to execute a host application that provides the user data; and
the UE comprises processing circuitry configured to execute a client application associated with the host application to receive the transmission of user data from the host.
   D3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the method of any of the Group B embodiments to transmit the user data from the host to the UE.
   D4. The method of the previous embodiment, further comprising, at the network node, transmitting the user data provided by the host for the UE.
   D5. The method of any of the previous 2 embodiments, wherein the user data is provided at the host by executing a host application that interacts with a client application executing on the UE, the client application being associated with the host application.
   D6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the method of any of the Group B embodiments to transmit the user data from the host to the UE.
   D7. The communication system of the previous embodiment, further comprising:
the network node; and/or
the user equipment.
   D8. The communication system of the previous 2 embodiments, wherein:
the processing circuitry of the host is configured to execute a host application, thereby providing the user data; and
the host application is configured to interact with a client application executing on the UE, the client application being associated with the host application.
   D9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform method of any of the Group B embodiments to receive the user data from the UE for the host.
   D10. The host of the previous 2 embodiments, wherein:
the processing circuitry of the host is configured to execute a host application, thereby providing the user data; and
the host application is configured to interact with a client application executing on the UE, the client application being associated with the host application.
   D11. The host of the any of the previous 2 embodiments, wherein the initiating receipt of the user data comprises requesting the user data.
   D12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the method of any of the Group B embodiments to receive the user data from the UE for the host.
   D13. The method of the previous embodiment, further comprising at the network node, transmitting the received user data to the host.
   D14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform the method of any of the Group A embodiments to receive the user data from the host.
   D15. The host of the previous embodiment, wherein the cellular network further includes a network node configured to communicate with the UE to transmit the user data to the UE from the host.
   D16. The host of the previous 2 embodiments, wherein:
the processing circuitry of the host is configured to execute a host application, thereby providing the user data; and
the host application is configured to interact with a client application executing on the UE, the client application being associated with the host application.
   D17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs the method of any of the Group A embodiments to receive the user data from the host.
   D18. The method of the previous embodiment, further comprising:
at the host, executing a host application associated with a client application executing on the UE to receive the user data from the UE.
   D19. The method of the previous embodiment, further comprising:
at the host, transmitting input data to the client application executing on the UE, the input data being provided by executing the host application,
wherein the user data is provided by the client application in response to the input data from the host application.
   D20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform the method of any of the Group A embodiments to transmit the user data to the host.
   D21. The host of the previous embodiment, wherein the cellular network further includes a network node configured to communicate with the UE to transmit the user data from the UE to the host.
   D22. The host of the previous 2 embodiments, wherein:
the processing circuitry of the host is configured to execute a host application, thereby providing the user data; and
the host application is configured to interact with a client application executing on the UE, the client application being associated with the host application.
   D23. A method implemented by a host configured to operate in a communication system that further includes a network node and a user equipment (UE), the method comprising:
at the host, receiving user data transmitted to the host via the network node by the UE, wherein the UE performs the method of any of the Group A embodiments to transmit the user data to the host.
   D24. The method of the previous embodiment, further comprising:
at the host, executing a host application associated with a client application executing on the UE to receive the user data from the UE.
   D25. The method of the previous embodiments, further comprising:
at the host, transmitting input data to the client application executing on the UE, the input data being provided by executing the host application,
wherein the user data is provided by the client application in response to the input data from the host application.

1.-41. (canceled)

42. A method performed by a relay communication device configured to relay traffic for a remote communication device, the method comprising:
receiving, from the remote communication device, an equipment identifier associated with the remote communication device;
transmitting, to a network node in a communication network, a report that reports the equipment identifier associated with the remote communication device as identifying the remote communication device for which the relay communication device is to relay traffic; and
relaying traffic between the remote communication device and the communication network.

43. The method of claim 42, wherein the equipment identifier is received in a request for the relay communication device to relay traffic for the remote communication device, wherein the request includes an emergency relay service code.

44. The method of claim 42, further comprising:
receiving, from the remote communication device, a request for the relay communication device to relay traffic for the remote communication device;
making a decision to transmit an identity request to the remote communication device, based on the received request lacking the equipment identifier; and
according to the decision, transmitting, to the remote communication device, an identity request requesting information identifying the remote communication device, wherein the equipment identifier is received in response to the identity request.

45. The method of claim 42, wherein the equipment identifier is a Permanent Equipment Identifier (PEI).

46. The method of claim 42, wherein said relaying comprises relaying traffic between the remote communication device and the communication network for an emergency service.

47. The method of claim 42, wherein the remote communication device lacks a universal integrated circuit card, or subscriber identity module, for storing a subscription identity associated with the remote communication device.

48. The method of claim 42, further comprising:
making a decision to skip a security procedure with the remote communication device, based on the relay communication device receiving the equipment identifier and an emergency relay service code; and
in accordance with the decision, skipping the security procedure with the remote communication device.

49. The method of claim 48, further comprising, based on skipping the security procedure with the remote communication device, performing a direct security mode command procedure with null ciphering and integrity protection.

50. The method of claim 49, wherein performing the direct security mode command procedure includes:
transmitting a message of the direct security mode command procedure with a flag indicating an algorithm chosen for the null ciphering and integrity protection; and/or
setting a root key to a value specific for null ciphering and integrity protection and/or setting each of one or more session keys to a value specific for null ciphering and integrity protection.

51. A method performed by a remote communication device, the method comprising:
transmitting, to a relay communication device configured to relay traffic for the remote communication device, an equipment identifier associated with the remote communication device; and
transmitting traffic to a communication network via the relay communication device, with the equipment identifier identifying the remote communication device to the communication network.

52. The method of claim 51, wherein the equipment identifier is transmitted in a request for the relay communication device to relay traffic for the remote communication device, wherein the request includes an emergency relay service code.

53. The method of claim 51, further comprising:
transmitting, to the relay communication device, a request for the relay communication device to relay traffic for the remote communication device, wherein the request lacks the equipment identifier; and
after transmitting the request, receiving, from the relay communication device, an identity request requesting information identifying the remote communication device, wherein the equipment identifier is transmitted in response to the identity request.

54. The method of claim 51, wherein the equipment identifier is a Permanent Equipment Identifier (PEI).

55. The method of claim 51, wherein the traffic is for an emergency service.

56. The method of claim 51, further comprising transmitting the equipment identifier, based on the traffic being for an emergency service and/or based on transmitting an emergency service relay code.

57. The method of claim 51, wherein the remote communication device lacks a universal integrated circuit card, or subscriber identity module, for storing a subscription identity associated with the remote communication device.

58. The method of claim 51, further comprising, based on failure of or skipping of a security procedure with the relay communication device, performing a direct security mode command procedure with null ciphering and integrity protection.

59. The method of claim 58, wherein performing the direct security mode command procedure includes:
receiving a message of the direct security mode command procedure with a flag indicating an algorithm chosen for the null ciphering and integrity protection; and/or
setting a root key to a value specific for null ciphering and integrity protection and/or setting each of one or more session keys to a value specific for null ciphering and integrity protection.

60. A method performed by a network node in a communication network, the method comprising:
receiving, from a relay communication device configured to relay traffic for the remote communication device, a report that reports an equipment identifier associated with the remote communication device as identifying the remote communication device for which the relay communication device is to relay traffic; and
using the equipment identifier to identify the remote communication device and/or to determine that the remote communication device has an ongoing session.

61. The method of claim 60, wherein the network node implements a Session Management Function (SMF).

62. The method of claim 60, wherein the equipment identifier is a Permanent Equipment Identifier (PEI).

63. The method of claim 60, wherein the relay communication device is to relay traffic for the remote communication device for an emergency service.

64. The method of claim 60, wherein the remote communication device lacks a universal integrated circuit card, or subscriber identity module, for storing a subscription identity associated with the remote communication device.

65. A relay communication device configured to relay traffic for a remote communication device, the relay communication device comprising:
communication circuitry; and
processing circuitry configured to:
receive, from the remote communication device, an equipment identifier associated with the remote communication device;
transmit, to a network node in a communication network, a report that reports the equipment identifier associated with the remote communication device as identifying the remote communication device for which the relay communication device is to relay traffic; and
relay traffic between the remote communication device and the communication network.

66. A remote communication device comprising:
communication circuitry; and
processing circuitry configured to:
transmit, to a relay communication device configured to relay traffic for the remote communication device, an equipment identifier associated with the remote communication device; and
transmit traffic to a communication network via the relay communication device, with the equipment identifier identifying the remote communication device to the communication network.

67. A network node of a communication network, the network node comprising:
communication circuitry; and
processing circuitry configured to:
receive, from a relay communication device configured to relay traffic for the remote communication device, a report that reports an equipment identifier associated with the remote communication device as identifying the remote communication device for which the relay communication device is to relay traffic; and
use the equipment identifier to identify the remote communication device and/or to determine that the remote communication device has an ongoing session.
